(19) United States
(12) Patent Application Publication
(10) Pub. No.: US 2013/0146458 A1
(43) Pub. Date: Jun. 13, 2013

(54) RAPID COMPACT ASSAY FOR PARENT RADIONUCLIDES IN GENERATORS

(71) Applicants: Weinberg Medical Physics LLC, Bethesda, MD (US); Irving N. Weinberg, Bethesda, MD (US); Pavel Stepanov, North Potomac, MD (US); Mario G. Urdaneta, Berwyn Heights, MD (US); Roland Probst, North Bethesda, MD (US); Valera Zavarzin, Newton, MA (US)

(72) Inventors: Irving N. WEINBERG, Bethesda, MD (US); Pavel STEPANOV, North Potomac, MD (US); Mario G. URDANETA, Berwyn Heights, MD (US); Roland PROBST, North Bethesda, MD (US); Valera ZAVARZIN, Newton, MA (US)

(73) Assignees: Irving N. Weinberg, Bethesda, MD (US); Pavel Stepanov, North Potomac, MD (US); Weinberg Medical Physics LLC, Bethesda, MD (US); Roland Probst, North Bethesda, MD (US); Valera Zavarzin, Newton, MA (US); Mario G. Urdaneta, Berwyn Heights, MD (US)

(21) Appl. No.: 13/738,357

(22) Filed: Jan. 10, 2013

Related U.S. Application Data
(63) Continuation-in-part of application No. 13/622,471, filed on Sep. 19, 2012.
(60) Provisional application No. 61/536,325, filed on Sep. 19, 2011.

(51) Int. Cl. G01N 27/447

(52) U.S. Cl. CPC G01N 27/447
USPC 204/452; 204/603; 204/602

(57) ABSTRACT

Disclosed embodiments assay for the presence of Ge-68, although disclosed embodiments can also be used for other radionuclide generators, with minimal adjustments.

This application is a continuation-in-part of U.S. patent application Ser. No. 13/622,471, entitled “RAPID COMPACT ASSAY FOR PARENT RADIONUCLIDES IN GENERATORS,” filed on Sep. 19, 2012, which relies for priority on U.S. Provisional Patent Application Ser. No. 61/536,325, entitled “RAPID COMPACT ASSAY FOR PARENT RADIONUCLIDES IN GENERATORS,” filed on Sep. 19, 2011, the entireties of which being incorporated by reference herein.

This invention was made with Government support under DE-SC0007568 awarded by DOE. The Government has certain rights in this invention.

### BACKGROUND

Ga-68 generators are portable and cost-effective tools for delivering high-resolution Positron Emission Tomography (PET) molecular imaging services to sites that are not physically close to a cyclotron. Clinical trials in Europe have demonstrated the abilities of Ga-68-labeled radiotracers to image tumors with high sensitivity and specificity, using such imaging to effectively plan therapy. Ga-68 generators employ Ge-68 as a parent isotope, with a half-life of 288 days, raising the possibility of unwanted breakthrough of Ga-68 in the fluid to be injected into patients. Outside the USA, historical data concerning Ge-68 breakthrough is considered adequate for quality control, while in the USA the FDA has taken a position that injection of patients should not be performed before assays have demonstrated that Ge-68 breakthrough is within acceptable limits, and the Nuclear Regulatory Commission (NRC) recommends testing each elution for breakthrough.

The gamma emissions of daughter Ga-68 have higher energies than the parent Ge-68, so that the shielding assays typically employed for Mo-99/Tc-99m generators cannot be applied to Ga-68 generators. The half-life of Ga-68 is about an hour, so that the 10-half-life delay (used in Sr-82/Rb-82 generators) cannot be effectively applied to Ga-68 generators, if we are to check each dose before administration to patients. As a result, Ga-68 generators are currently sold in the USA for animal or research use only.

### SUMMARY

The primary purpose of the disclosed embodiments is to assay for the presence of Ge-68, although disclosed embodiments can also be used for other radionuclide generators, with minimal adjustments.

### BRIEF DESCRIPTION OF THE FIGURES

FIG. 1 illustrates one example of a compact assay device containing a disposable microfluidic chip, in which the separation and detection of Ge-68 takes place.

FIG. 2 is an illustration of the process of isotachophoresis.

FIG. 3 illustrates simulations that emulate an expected operation according to the disclosed embodiments.

FIG. 4 is a schematic showing operation of a disclosed embodiment.

FIG. 5 shows an embodiment of the apparatus configured for confirmation using radioactive assays.

### DETAILED DESCRIPTION

Disclosed embodiments takes advantage of recent technological advances (e.g., isotachophoresis and picomolar assays of heavy metals) employed for Lab-On-a-Chip (LOC) applications. Isotachophoresis (ITP) allows the separation of species (e.g., atoms, molecules) at extremely low concentrations.

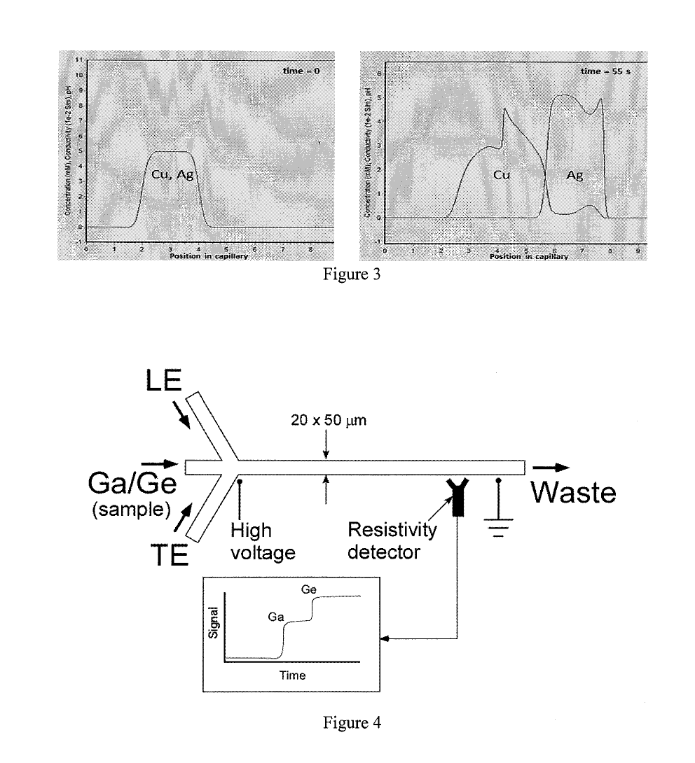

Electrophoresis is widely used to separate and identify proteins, DNA, and inorganic ions. The classic electrophoresis method consists of placing a small volume of the solution to be analyzed (i.e., the analyte) in a channel pre-filled with an electrolyte, and then applying a voltage at the ends of the channel. The charged analytes will move to the electrode of opposite charge. A detector at the end of the channel registers the presence of analytes as they move past the detector. To achieve separation of analytes, electrophoresis relies on the fact that different analytes move at different speeds in an applied electric field. As the analytes travel down the channel, they separate into bands. The fastest analytes form a band at the front of the pack, and the slowest at the end. The speed of each analyte depends on its mobility. Based on simulations shown below (FIG. 2), classical electrophoresis may not be able to separate Ga and Ge ions within a column less than 25 cm long (i.e., in a compact assay system). An embodiment of the invention includes isotachophoresis (ITP), a variant of electrophoresis (FIG. 3).

An ITP system is comprised of a channel, a voltage source connected to the ends of the channel, and a detector near an end of the channel. Two different electrolytes, one in front of the sample and one behind it (denoted as the leading and trailing electrolytes, or LE and TE) are used, in contrast to classical electrophoresis (which uses only one electrolyte). LE promotes faster migration velocity, and the TE promotes slower migration velocity of the analytes, causing the analytes to concentrate in very narrow bands. As the analytes cross the detection region, changes in the conductivity of the sample are recorded, with the fast analytes crossing sooner and the slow analytes crossing later. The timing and the size of the detector signal give information about the identity and abundance of each analyte.

With ITP, analytes form narrower bands than in electrophoresis because of a self-sharpening effect, thus concentrating the analytes by a factor of about one million. Detection of ions in concentrations as low as 0.1 pM in less than a minute have been reported with ITP (see, for example, the article by B Jung, R Bharadwaj, and J G Santiago, entitled “On-chip millionfold sample stacking using transient isotachophoresis,” published in the journal Analytical Chemistry, 78(7):2319-2327, 2006, the teachings of which being incorporated by reference herein). With ITP (FIG. 4), it is possible to utilize small sample volumes, short separation time, assay automation, and smaller overall system size.

Specification of the leading (LE) and terminating (TE) electrolytes and buffer solutions is of great importance in determining the degree of separation of species into bands. Chelating agents (e.g., with EDTA or citric acid) might be added to the buffers, to modify the mobility of metal ions. Key to selecting these combinations is knowledge of the effective mobilities that the various ionization forms of Ga and Ge can take (e.g., GaCl4-, GaOH2+, Ga3+).

It should be noted that the invention is not limited to using ITP for separation, and that other variations of electrophoretic techniques may also be applicable. Examples of such techniques include the capillary zone electrophoresis (CZE).

A CZE system is comprised of a thin channel (for example, less than one millimeter in inner diameter), a voltage source connected to the ends of the channel, and a detector near an end of the channel. A single electrolyte is used in the channel. A small amount of the analytes to be separated is inserted somewhere in the middle of the channel, with electrolyte on either side of the sample. A voltage is applied across both ends of the channel. The analytes in the sample region move towards the electrode of opposite charge in discrete bands of length roughly equal to the length that the initial analyte mix occupied. The speed of the band for each analyte depends on their mobility, thus bands comprised of faster analytes will arrive to the detector sooner than bands of slower analytes. As the analytes cross the detection region, changes in the conductivity of the sample are recorded. The timing and the size of the detector signal give information about the identity and abundance of each analyte.

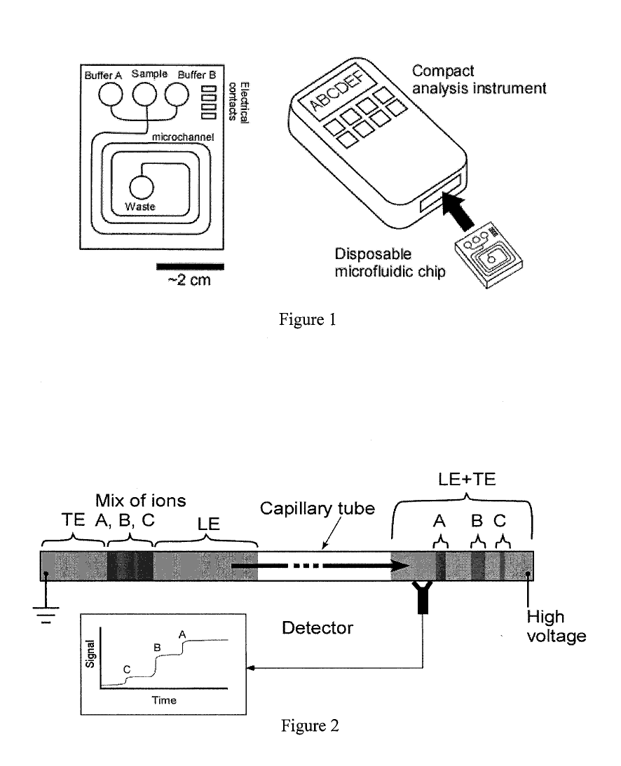

Disclosed embodiments can be configured as a compact assay device containing a disposable microfluidic chip, in which the separation and detection of Ge-68 takes place (FIG. 1). The device may house components and systems (e.g., fluid reservoirs, power supply) needed to operate the chip. After the assay, the disposable chip could be removed from the device and properly disposed of. The device would then be ready to perform another assay upon loading a new chip.

The electrophoretic technique to be used can also be augmented by enriching the concentration of analytes prior to separation. This is especially useful if the concentration of analytes of interest is very low. One example of such enriching method is electrokinetic supercharging (“EKS”) (see, for example, the article by Z Xu, K Nakamura, A Timerbaev, and T. Hirokawa, entitled “Another approach toward over 100 000-fold sensitivity increase in capillary electrophoresis: Electrokinetic supercharging with optimized sample injection” published in the journal Analytical Chemistry, 83(1), 398-401, 2011, the teachings of which being incorporated by reference herein). Other methods for sample enrichment include field assisted sample stacking (see, for example, the article by B Jung, R Bharadwaj, J Santiago, entitled “Thousandfold signal increase using field-amplified sample stacking for on-chip electrophoresis”, published in the journal Electrophoresis, 24(19-20), 3476-3483, 2003) and transient isotachophoresis (see, for example, the article by B. Jung, R. Bharadwaj, and J Santiago, entitled “On-chip millionfold sample stacking using transient isotachophoresis”, published in the journal Analytical Chemistry, 78(7), 2319-2327, 2006, the teachings of which being incorporated by reference herein).

An electrophoresis system that implements EKS in this invention is comprised of a channel with reservoirs at one or both ends, a voltage source connected to the channel reservoirs, and a detector near an end of the channel. The channel is mostly filled with an electrolyte of high conductivity. The analyte is dissolved in a solution of lower conductivity as compared to the electrolyte in the channel, and this new solution is loaded at the entrance end of the channel. A voltage is applied across the reservoirs so that an electric field is created along the channel. The electric field will be greater in the solution of low conductivity, which initially contains the analytes of interest. The analytes will then move towards the interface between the two solutions at a relatively fast speed. When the analytes reach the interface between the two solutions, the analytes encounter a lower electric field as they cross to the region of electrolyte of high conductivity, and move as a slower speed. As the analytes slow down, they concentrate at the interface. The analytes separate according to their mobility in the section of the channel with higher conductivity. As the analytes cross a detection region, changes in the conductivity of the sample are recorded. The timing and the size of the detector signal due to conductivity give information about the identity and abundance of each analyte.

The invention consists of a method and apparatus that uses the principles of ion separation, including electrophoresis and some of its variants as described above, primarily for the purpose of detecting minute amounts of long-lived radioactive contaminants in a fluid solution.

As illustrated in FIG. 1, an embodiment of the apparatus of the invention contains a thin channel within a microfluidic chip (left) designed to separate ions from the Ge/Ga generator eluent, with the chip fitting within a compact analyzer (right). The chip has fluid inlets (buffer A/sample/buffer B) and outlets (waste), and electrical contacts, all of which interface with the analyzer. The system envisioned is semi-automated, easy to use, and affordable and fast enough that it makes testing the radiotracer dose of each patient a possibility. The channel can be in the form of a capillary or trench.

In one embodiment of the invention, the fabrication process for the microfluidic chip may start with the etching of a substrate (e.g., a silicon wafer) using Deep Reactive Ion Etching (DRIE) to make a mold. The mold may then be placed on a sheet of polycarbonate and heated. The pattern in the silicon wafer may then be transferred onto the polycarbonate. Upon cooling, the mold can be removed and re-used. Fluidic ports may then be drilled in the polycarbonate at appropriate locations. A separate piece of glass may be covered with gold (using chromium as adhesion layer, and deposited through thermal evaporation, for example) and the gold patterned with the impedance electrodes using mask lithography. The polycarbonate channel may then be covered with the glass to close the channel, and the whole chip heated to achieve a proper bonding.

Alternatively, the fabrication process for the microfluidic chip may start with the etching of a substrate (e.g., a silicon wafer) using Deep Reactive Ion Etching (DRIE) to make a mold. A flexible polymer, such as polydimethylsiloxane (also commonly known as PDMS) may be cast on top of the mold. Upon curing, the flexible polymer may be peeled off the mold. Since the polymer cured around the features in the mold, these features are now transferred to the polymer. Fluidic ports may then be then punched in the flexible polymer at appropriate locations. A separate piece of glass may be covered with gold (using chromium as adhesion layer, and deposited through thermal evaporation, for example) and the gold patterned with the impedance electrodes using mask lithography. The flexible polymer channel may then be covered with the glass to close the channel, and the whole chip heated to achieve a proper bonding.

Solution conductivity may be monitored (to identify the ions) using low-voltage Alternating Current (AC) impedance measurements through a pair of electrodes fabricated in the channel. This method has been shown to detect changes in conductivity small enough to detect 10-7 M ion concentrations (as in the article by L Chen, S Lee, J Choo, and E K Lee, entitled “Continuous dynamic flow micropumps for microfluid manipulation,” Journal of Micromechanics and Microengineering, 18(1): 013001, published in 2008, the teachings of which being incorporated by reference herein).

FIG. 2 illustrates on the application of ITP as used in an embodiment of the invention. Unlike classical electrophoresis, isotachophoresis employs a non-linear approach with multiple electrolytes that causes self-sharpening of the samples (thus enabling compact systems). As shown in FIG. 2, a capillary channel is filled with a Leading Electrolyte (LE), an analyte (containing the ions of interest A, B, C), and a Trailing Electrolyte (TE).

An applied high voltage drives ions to the end of the channel. LE and TE are chosen so that the ions form separate bands, each with a concentration more than a million times greater than the original concentration. A conductivity detector measures changes produced by the ion bands as they travel past.

The timing and size of the conductivity signal produced by the band of ions identifies the species and its concentration. The integrated conductivity signal in ITP is shown in FIG. 2, whose derivative corresponds to the pulses typically shown with optical absorption methods.

FIG. 3 shows one example of simulations that emulate the expected operation resulting from performance of the disclosed embodiments. To emulate Ge and Ga, Cu and Ag ions may be used because these elements have similar atomic numbers, their valence numbers differs by one electron, and their effective mobilities are known. In FIG. 3, simulations were performed in Simul 5.0 with 10 mM of hydroiodic acid as LE and 10 mM of citric acid as TE.

FIG. 4 is a schematic showing the standard operation of one disclosed embodiment. The apparatus may have three inlets: one for the leading electrolyte, one for the sample to be analyzed (i.e., containing Ga-68/Ge-68), and one for the trailing electrolyte. The presence of analytes may be detected by measuring the resistivity of the fluid as a function of time, and comparing it to known references. The resistivity and electric field electrodes may be integrated into the device.

Although the invention is described herein for the purpose of detecting the long-lived radioactive contaminant Ge-68, the invention may be used to confirm the presence of other long-lived radioactive contaminants.

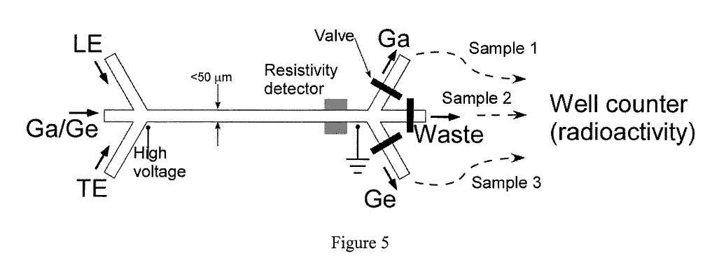

FIG. 5 shows the apparatus configured for confirmation of the presence of long-lived radioactive contaminant using radioactive assays. Measuring the radioactivity of Ga-68 and Ge-68 collected separately serves as a “gold-standard.” The Ga-68 and Ge-68, which are separated in the channel, may then be sent to separate vials with the aid of valves. These vials can be tested separately after 10-half-lives in a well counter for radioactivity. Alternatively, the radioactivity can be assayed on the chip or in the device.

In addition to benefiting from by the million-fold concentration afforded by ITP, impedance measurements implemented by an embodiment of the invention may detect very low ion concentrations (for example, in the order of tens of pM). In order to implement this increase in sensitivity, an AC signal is applied across the sensor electrodes to monitor the impedance that the signal experiences. Although electrical impedance measurements may be less sensitive than optical detection, measuring impedance may be easier and less expensive to implement than optical means. Alternatively, optical means of assaying the concentration of Ge-68 may be used (using a method disclosed in the article by MA Schwarz and PC Hauser, entitled “Recent developments in detection methods for microfabricated analytical devices,” Lab on a Chip, 1(1), published in 2001, the teachings of which being incorporated by reference herein).

A commercial product based on disclosed embodiments may include the following components in the system: high voltage power supplies, function generator, data acquisition in integrated circuit format, and syringe or electro-osmotic pumps. Various materials and solutions may be used for LE, TE, and buffer, for example: NaOH, HCl, MES, Tris, malic acid, boric acid, HIBA. HCl, at different concentrations, would be a good starting point, given that HCl is used as eluant in Ge-68/Ga-68 generators.

Impedance measurements may prove to be inadequate for measuring the small changes in solution conductivity produced by the low ion concentrations that need to be detected. This could be the case for a variety of reasons (e.g., electrical noise). In an alternative embodiment, optical absorbance measurements in the UV range may be used to detect of separated ions. Optical absorbance measurements can be more sensitive than impedance measurements to the presence of the ions, and less prone to noise.

In an alternative embodiment, users of the invention may have the option of validating the conduction sensor using classic 10-half-life routines. This option may be implemented by including computer-controlled valves integrated with the microfluidic chip, as illustrated in FIG. 5. In this embodiment, bands where Ga and Ge are expected are sent to different outlets with switching valves or other means and are collected as separate samples in a reservoir on the microfluidic chip or are output to one or more containers. The radioactivity of these samples is then measured using a well counter or an on-board radiation sensor; the putative Ge sample will display radioactivity only if Ge is present, since most or all of the Ga has been directed to a different outlet. This putative Ge sample will display radioactivity after 10-half-lives only if Ge-68 was actually present.

Another embodiment of the invention is to detect Germanium-68 by depleting a region of a confined space (for example, a capillary tube) of other ions, for example by moving the Gallium-68 from the capillary under the influence of an electric field. Having depleted the region of other radioactive materials, most or all of the radioactivity and/or conductivity measured from this region may be due to the presence of Germanium-68. The radioactivity may be measured from gamma- or beta-particles or other forms of radiation collected outside or inside the confined space.

In an embodiment of the invention, all or some of Ga ions from the solution can be removed from a sample in order to improve the detectability of Ge ions. This can be done using an ion exchange column before the solution is delivered to the channel, or by incorporating ion exchange materials into a portion of the channel. Ion exchange columns retain preferentially some ions over others depending on the conditions of the ion exchange/solvent system. For example, an ion exchange column made of Dowex 1 anion exchange resin (Dow Chemical) using 4M HCl as a solvent will retain Ga preferentially over Ge by a factor of approximately 100,000. In an embodiment of the invention, the solution to be analyzed is flowed through an ion exchange column which preferentially absorbs Ga as compared to Ge. The solution that flows out of the ion exchange column is collected. This Ga-depleted solution is then used in the apparatus described herein to detect and measure the presence of Ge. Alternatively, the use of an ion exchange column/solvent system that retains Ge preferentially over Ga ions would be as follows: one would flow the solution that contains Ga, and presumably Ge, through the ion exchange column. Then the column would be rinsed with a solvent that releases the Ge from the column. This rinsing solution would collect the Ge ions from the column, if any Ge ions were present in the original sample solution. One would then use the apparatus described herein using the rinsing outflow from the column.

In an alternative embodiment, all or part of Ga ions in the analyte solution are removed by placing the solution in an electric field such that the Ga ions are preferentially immobilized at the electrode or precipitated prior to insertion of the solution into the thin channel. In an alternative embodiment, chemicals can be added to the solution so as to favor the conditions under which the preferential immobilization or precipitation takes place before or during insertion of the sample into the thin channel. Such additives include, but are not limited to, buffers to control or modify the pH of the solution, inorganic compounds that react preferentially with Ga over Ge, and organic chelating agents.

In the cases where the Ga ions are fully or partially removed or immobilized from the solution to be analyzed, the invention can be used to detect and confirm the presence of Ge. In other words, an embodiment of the invention is to remove or immobilize Ga ions, and then use the apparatus or methods presented herein to identify Ge in the solution by using the timing of a signal to confirm that Ge ions are present.

The ionic state of Germanium-68 upon its release from a column in a generator may not be known ahead of time. In order to force the Germanium-68 into an ionic state that may be separable with the invention, a chemical (for example, nitric acid) may be introduced into the solution or the pH of the solution may be varied with another chemical.

What is claimed:

1. An apparatus for detection of breakthrough of long-lived radioactive material in the eluent from a generator, the apparatus comprising:
at least one channel through which some or all of the eluent from the generator passes through;
an electric field generator coupled to a plurality of electrodes located near or in the at least one channel, wherein a concentration of ions at a plurality of positions within the at least one channel is influenced by introducing electrostatic or electrodynamic forces on the ions via the electric field generator; and
at least one sensor that characterizes the concentration of ions of the radioactive material that have passed through at least a portion of the at least one channel.

2. The apparatus of claim 1, wherein the at least one sensor is located near or in the at least one channel.

3. The apparatus of claim 1, wherein the at least one sensor is located outside the at least one channel.

4. The apparatus of claim 1, wherein the radioactive material is germanium-68.

5. The apparatus of claim 1, further comprising an ion-exchange column located proximate to the at least one channel, wherein the eluent is pre-filtered through the ion-exchange column prior to entering at last one portion of the at least one channel.

6. The apparatus of claim 1, wherein the at least one channel is less than 1 mm in inner diameter.

7. The apparatus of claim 1, wherein the at least one channel is less than 100 microns in inner diameter.

8. The apparatus of claim 1, wherein the at least one channel is formed in a microfluidic chip.

9. The apparatus of claim 8, wherein the microfluidic chip is a single-use device and is configured to reduce radioactive contamination between measurements.

10. The apparatus of claim 1, where the at least one sensor comprises capacitive electrodes, in which at least one electrode monitors the current in the at least one channel in response to an oscillating electric field applied with at least one additional electrode, and wherein the apparatus further comprises an amplifying circuit coupled to the sensor so as to amplify the signal supplied by the at least one sensor.

11. The apparatus of claim 1, wherein sensing of the ions in the at least one thin channel is performed by monitoring a voltage or current between at least one of the electrodes used to apply the electric field responsible for separating the ions, and another electrode.

12. The apparatus of claim 1, where the at least one sensor monitors optical properties of ions or of a combination of ions with one or more chemical substances added to the eluent, and wherein the apparatus further comprises an amplifying circuit that is coupled to the at least one sensor and receives a signal output by the at least one sensor and amplifies and digitizes the signal and outputs the resulting output signal to a computer.

13. The apparatus of claim 12, wherein the output signal is analyzed by software running on the computer to determine whether the concentration of the long-lived radioactive material is below a pre-selected threshold.

14. The apparatus of claim 1, wherein that at least one channel includes a port for the addition of one or more chemical substances to the eluent.

15. The apparatus of claim 1, wherein an ion charge state is affected by addition of one or more chemical substances to the eluent.

16. The apparatus of claim 1, wherein separation of ions of the radioactive material from the eluent is performed using isotachophoresis.

17. The apparatus of claim 1, wherein separation of ions of the radioactive material from the eluent is performed using capillary zone electrophoresis.

18. The apparatus of claim 1, wherein separation of ions of the radioactive material from the eluent is enhanced using electrokinetic supercharging.

19. The apparatus of claim 1, wherein separation of ions of the radioactive material from the eluent is enhanced using field assisted sample stacking.

20. The apparatus of claim 1, wherein separation of ions of the radioactive material from the eluent is enhanced using transient isotachophoresis.

21. The apparatus of claim 1, wherein non-radioactive solutions of ions are used to calibrate the apparatus as a quality control measure.

22. A method for detecting breakthrough of long-lived radioactive material in the eluent from a generator, the method comprising:
directing some or all of the eluent to pass through at least one channel;
applying an electric field to the at least one channel via electrodes near or in the at least one channel;
influencing a concentration of ions at a plurality of positions within the at least one channel by introducing electrostatic or electrodynamic forces on the ions; and
characterizing the concentration of ions of the radioactive material that have passed through at least a portion of the at least one channel using at least one sensor.

23. The method of claim 22, wherein the radioactive material is germanium-68.

24. The method of claim 22, further comprising pre-filtering the eluent using an ion-exchange column prior to entering at last one portion of the at least one channel.

25. The method of claim 22, wherein the at least one channel is less than 1 mm in inner diameter.

26. The method of claim 22, wherein the at least one channel is less than 100 microns in inner diameter.

27. The method of claim 22, wherein the at least one channel is formed in a microfluidic chip.

28. The method of claim 27, wherein the microfluidic chip is a single-use device.

29. The method of claim 22, where the at least one sensor comprises capacitive electrodes, in which at least one electrode monitors the current in the at least one channel in response to an oscillating electric field applied with at least one additional electrode, and wherein the apparatus further comprises an amplifying circuit coupled to the sensor so as to amplify the signal supplied by the at least one sensor.

30. The method of claim 22, wherein sensing of the ions in the at least one channel is performed by monitoring a voltage or current between at least one of the electrodes used to apply an electric field responsible for separating the ions, and another electrode.

31. The method of claim 22, where the at least one sensor monitors optical properties of ions or of a combination of ions with one or more chemical substances added to the eluent, and wherein the apparatus further comprises an amplifying circuit that is coupled to the at least one sensor and receives a signal output by the at least one sensor and amplifies and digitizes the signal and outputs the resulting output signal to a computer.

32. The method of claim 31, wherein the output signal is analyzed by software running on the computer to determine whether the concentration of the long-lived radioactive material is below a pre-selected threshold.

33. The method of claim 22, wherein an ion charge state is affected by addition of one or more chemical substances to the eluent.

34. The method of claim 22, further comprising separation of the ions of radioactive material from the eluent using isotachophoresis.

35. The method of claim 22, further comprising separation of the ions of radioactive material from the eluent using capillary zone electrophoresis.

36. The method of claim 22, further comprising separation of the ions of radioactive material from the eluent using electrokinetic supercharging.

37. The method of claim 22, further comprising separation of the ions of radioactive material from the eluent using field assisted sample stacking.

38. The method of claim 22, further comprising separation of the ions of radioactive material from the eluent using transient isotachophoresis.

39. The method of claim 22, further comprising performing calibration using non-radioactive solutions of ions as a quality control measure.
